(19) United States
(12) Patent Application Publication
(10) Pub. No.: US 2026/0355959 A1
(43) Pub. Date: Nov. 12, 2026

(54) GENERATIVE 3D MODEL OF HAND OBJECT INTERACTIONS

(71) Applicant: Microsoft Technology Licensing, LLC, Redmond, WA (US)

(72) Inventors: Benjamin Eliot LUNDELL, Seattle, WA (US); Harpreet Singh SAWHNEY, Kirkland, WA (US); Dmitry Petrovich ANDREYCHUK, Redmond, WA (US); . ADITYA PRAKASH, Champaign, IL (US)

(21) Appl. No.: 19/200,145

(22) Filed: May 6, 2025

(51) Int. Cl. B25J 9/16; G05B 13/02

(52) U.S. Cl. CPC B25J 9/1671; B25J 9/163; G05B 13/0265

(57) ABSTRACT

Techniques for generating a latent codebook and for generating instructions indicating how an action is performed against an object using the latent codebook are disclosed. The latent codebook is created by generating interaction trajectories that occur during an action performed by a gripping structure against an object. The vectors in the latent codebook describe actions by mapping trajectories of contact points between gripping structures and objects during performance of actions. A service then accesses an image of a second object that is to be manipulated. The service obtains an instruction indicating that the specific action is to be performed against the second object. In response to accessing a vector in the latent codebook, the service uses the image to localize the vector to the second object. The service then generates a sequence of instructions that represent the action as applied to the second object.

### BACKGROUND

The phrases “remote instruction,” “remote training,” and “remote learning” generally refer to a scenario involving an expert that is situated at a different location than a place where a task is being performed. In this scenario, it is desirable to leverage the expertise of the expert for training purposes, such as training another human or perhaps training an autonomous robot to complete a task. Consider, for instance, the example presented below.

Suppose a person or a robot is tasked with changing the oil filter on a car, but the person or the robot currently does not know how to accomplish that task. As such, the person or robot will employ the use of an expert to provide education on the task. Ideally, the training process would likely involve the expert recording him/herself performing the same action and then providing the recording to the trainee (e.g., the human or robot). In the above scenario, the ideal situation would be for the expert to record him/herself changing the exact same oil filter as the trainee is tasked with changing.

In some scenarios, artificial intelligence (AI) can be employed to further enhance the process. For instance, the AI can analyze the training video and provide additional insights or instructions regarding the task. As another example, the AI can identify specific parts or tools that are involved. In some other situations, the training process can be augmented or further supplemented through the use of head-mounted devices (HMDs), or other wearable devices. These types of devices are able to provide a so-called “extended reality” experience.

The phrase “extended reality” (XR) is an umbrella term that describes various types of immersive platforms. Such immersive platforms include virtual reality (VR) platforms, mixed reality (MR) platforms, and augmented reality (AR) platforms. An XR system, or XR platform, provides a “scene” to a user. As used herein, the term “scene” generally refers to any simulated environment (e.g., three-dimensional (3D) or two-dimensional (2D)) that is displayed by an XR system.

For reference, conventional VR systems create completely immersive experiences by restricting their users'views to only virtual environments. This is often achieved through the use of an HMD that completely blocks any view of the real world. Conventional AR systems create an augmented-reality experience by visually presenting virtual objects that are superimposed into a view of the real world. Conventional MR systems also create an augmented-reality experience by visually presenting virtual objects that are superimposed into a view of the real world, and those virtual objects are typically able to be interacted with by the user. Furthermore, virtual objects in the context of MR systems can also appear as though they are interacting with real world objects. AR and MR platforms can also be implemented using an HMD. XR systems can also be implemented using laptops, handheld devices, HMDs, and other computing systems.

Unless stated otherwise, the descriptions herein apply equally to all types of XR systems, which include MR systems, VR systems, AR systems, and/or any other similar system capable of displaying virtual content. An XR system can be used to display various types of information to a user. Some of that information is displayed in the form of a “hologram.” As used herein, the term “hologram” generally refers to image content that is displayed by an XR system. In some instances, the hologram may appear as a 3D object to a user, while in other instances the hologram may appear as a 2D object. In some instances, a hologram can also be implemented in the form of an image displayed to a user.

Continued advances in hardware capabilities and rendering technologies have greatly increased the realism of holograms and scenes displayed to a user within an XR environment. For example, a hologram can be placed within an XR environment in such a way as to give the impression to a user that the hologram is part of the real world. As a user moves around within the real world, the XR environment automatically updates so that the user is provided with the proper perspective and view of the hologram. This XR environment is the “scene” mentioned previously. Optionally, a training recording can be displayed via the use of the XR system, and various holograms can be used to supplement the recording.

Humans have the strong ability to infer and intuit actions that are occurring around them. Robots and other autonomous entities, on the other hand, do not have the inherent intuitiveness that a human does. What is needed, therefore, is an improved way for training robots and other AI related scenarios on task-based situations, particularly those involving hand-object-interactions, or gripping object interactions.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In some aspects, the techniques described herein relate to a method for generating instructions indicating how an action is performed against an object that was not previously mapped, said method including: accessing a latent codebook including a vector, wherein the vector describes a specific action that is performed by a first gripping structure against a first object, wherein the vector describes the specific action by mapping a trajectory of contact points between the first gripping structure and the first object during performance of the specific action; accessing an image of a second object that is to be manipulated, wherein the second object is different from the first object; obtaining an instruction indicating that the specific action is to be performed against the second object; in response to accessing the vector in the latent codebook, using the image to localize the vector to the second object, wherein localizing the vector to the second object includes modifying a first dimensionality associated with the first object, as described in the vector, to account for a second dimensionality of the second object, as identified by the image, such that a new trajectory of new contact points between a second gripping structure and the second object are generated; and generating a sequence of instructions that represent the specific action as applied to the second object, wherein the sequence of instructions identifies the new trajectory of the new contact points between the second gripping structure and the second object, such that the sequence of instructions facilitates performance of the specific action against the second object.

In some aspects, the techniques described herein relate to a computer system including: a processor system; and a storage system that stores instructions that are executable by the processor system to cause the computer system to: access a latent codebook including a vector, wherein the vector describes a specific action that is performed by a first gripping structure against a first object, wherein the vector describes the specific action by mapping a trajectory of contact points between the first gripping structure and the first object during performance of the specific action; access an image of a second object that is to be manipulated, wherein the second object is different from the first object; obtain an instruction indicating that the specific action is to be performed against the second object; in response to accessing the vector in the latent codebook, use the image to localize the vector to the second object, wherein localizing the vector to the second object includes modifying a first dimensionality associated with the first object, as described in the vector, to account for a second dimensionality of the second object, as identified by the image, such that a new trajectory of new contact points between a second gripping structure and the second object are generated; and generate a sequence of instructions that represent the specific action as applied to the second object, wherein the sequence of instructions identifies the new trajectory of the new contact points between the second gripping structure and the second object, such that the sequence of instructions facilitates performance of the specific action against the second object.

In some aspects, the techniques described herein relate to one or more hardware storage devices that store instructions that are executable by a processor system to cause the processor system to: access a latent codebook including a vector, wherein the vector describes a specific action that is performed by a first gripping structure against a first object, wherein the vector describes the specific action by mapping a trajectory of contact points between the first gripping structure and the first object during performance of the specific action; access an image of a second object that is to be manipulated, wherein the second object is different from the first object; obtain an instruction indicating that the specific action is to be performed against the second object; in response to accessing the vector in the latent codebook, use the image to localize the vector to the second object, wherein localizing the vector to the second object includes modifying a first dimensionality associated with the first object, as described in the vector, to account for a second dimensionality of the second object, as identified by the image, such that a new trajectory of new contact points between a second gripping structure and the second object are generated; and generate a sequence of instructions that represent the specific action as applied to the second object, wherein the sequence of instructions identifies the new trajectory of the new contact points between the second gripping structure and the second object, such that the sequence of instructions facilitates performance of the specific action against the second object.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example computing architecture in which a service can generate a latent codebook and subsequently use that latent codebook to localize vector data to a current scenario.

FIG. 2 illustrates an example of a training image.

FIG. 3 illustrates an example of a three-dimensional (3D) hand mesh generated from the training image.

FIG. 4 illustrates how contact points between the hand and an object can be represented as binary masks.

FIG. 5 illustrates an example process flow for generating a latent codebook.

FIG. 6 illustrates an example process flow for using the latent codebook.

FIGS. 7A and 7B illustrate flowcharts of example methods involving the latent codebook.

FIG. 8 illustrates an example computer system that can be configured to perform any of the disclosed operations.

### DETAILED DESCRIPTION

The disclosed embodiments are beneficially designed to operate in scenarios where a model for a given object may not be available and a specific task involving that object may not be fully measurable. For instance, it might be the case that a task model for rotating a screw using a screwdriver is available, but it might be the case that a task model for rotating a lid off of a pickle jar is not available. The disclosed embodiments are beneficially structured to enhance or abstract the existing task model for rotating the screw and localize that task model to a related task, such as rotating the lid off of the pickle jar. These operations are performed by mapping various hand-object-interactions and then expanding those interactions to other, sufficiently similar (e.g., within a threshold level of similarity) scenarios.

Some embodiments are configured to identify a nearest neighbor model to a given situation and then abstract that model for the current situation. Other embodiments, however, do not perform a nearest neighbor analysis. Instead, such models rely on a neural network that identifies a most efficient manner for representing data via the smallest number of dimensions. Such operations, as will be described in more detail later, involve the use of a so-called “latent codebook” and the involvement of the neural network, which identifies a scenario involving the closest hand-object-interaction. Again, further details on these aspects will be provided later.

As a quick introductory example, consider a scenario where a series of poses of a user's hand relative to a screwdriver are available. This series of poses (aka a sequence of waypoints) may indicate the specific grip (e.g., the number of fingers involved) as well as the pose of the user's hand in performing the action. That is, the series of poses generally reflect a set of contact points between the user's hand (or gripping body) and the object. The series of poses can be reflected in time-series data via a set of image frames in the form of a video recording. After learning the contact poses and trajectories from the training recording, the embodiments are able to abstract that series of poses (e.g., the contact points) for use in the scenario involving the lid of the pickle jar, which was not mapped in the latent codebook. In doing so, the embodiments can be employed in scenarios where object models and tasks related to those objects are not immediately available. Such operations significantly enhance the utility and productivity of task-based operations by generalizing contact points and trajectories/poses to new, not previously modeled situations.

It should be noted that while many of the examples recited herein are directed to scenarios involving the training or implementation of a robot, the disclosed principles are not limited to robot-based scenarios. Indeed, the disclosed principles can be adopted in numerous other scenarios, including any type of extended reality scenario involving holograms, among others. Thus, the disclosed principles should be interpreted in a broad manner and without limit.

The disclosed embodiments beneficially predict three-dimensional (3D) hand motion and contact maps (aka “interaction trajectories”) given a single red-green-blue (RGB) view (though other image types or input types can be used, as discussed in more detail later), action text (i.e. an “instruction”), and a 3D contact point on a given object as input. At least some embodiments implement a model (e.g., optionally a VQVAE model) that learns a latent codebook of hand poses and contact points, thereby effectively tokenizing interaction trajectories.

Some embodiments also utilize a transformer-decoder module that predicts the interaction trajectory from test time inputs by using an indexer module to retrieve a latent affordance from the learned codebook. To train the model, some embodiments develop a data engine that extracts 3D hand poses and contact trajectories from a diverse dataset. Some embodiments also evaluate the model and test for generalization of the model across object categories, action categories, tasks, and scenes.

The term “affordances” refers to a set of functionalities that the environment furnishes to an agent, which can be a human, a robot, an animal, or hands. Affordances are typically represented as the contact regions on the objects and the agent. Affordances have been explored in domains such as robotics, human interactions, and hand grasp synthesis.

Hands interact with objects in diverse ways, often requiring varying skill levels to complete different tasks. For example, consider teaching someone to repair a bike. It is challenging to specify what part(s) to manipulate, what axis to flip a part over such that it inserts well, and so on. Instead, it is easier to directly show how the hand should move and what parts of the hand should make contact with the object over time to complete the task. The disclosed embodiments provide various solutions to these types of challenges.

By way of example, given one or more images of an object, a 3D contact point, and a text indicating the high-level action, some embodiments are able to predict interaction trajectories as well as the sequence of 3D hand poses and contact maps that specify the initial and evolving hand interactions needed to complete the task. Some embodiments are designed to target interaction with everyday objects that are often small, thin, transparent, occluded, and deformable for which 3D object models may not be available. Some embodiments are designed to initially learn a motion for diverse interactions in everyday activities, where those motions can be combined with 3D object models in the future.

In the absence of a 3D model, explicitly specifying contact points in the scene grounds the hand-object-interaction, especially when there are multiple objects and when 3D models are not available. The hand-object-interaction information is provided in the form of a 3D contact point.

Moreover, it can be observed that while objects are diverse, hands interact with them in stylized ways. That is, there are only a few prototypical ways in which hands act in everyday interactions. To exploit this property, some embodiments learn a latent codebook of trajectories of 3D hand motions and contact points, thereby effectively tokenizing interaction trajectories using a vector quantized variational autoencoder (VQVAE).

The codebook learns the prototypical motion involved in, as one example, screwing in a screw. This motion can be repurposed into motion involved in, as another example, closing a bottle cap. The codebook is indexed using visual inputs at test time to retrieve the closest codebook entry and is aligned with the current scene using the 3D contact point and visual context from the image input. This technique is referred to herein as “LatentAct.” Because existing hand-object-interaction (HOI) datasets with 3D annotations have constrained setups, some embodiments use egocentric videos from an extended reality dataset showing everyday interactions. Some embodiments leverage 3D hand pose estimation and segmentation in videos to build a semi-automatic data engine to extract trajectories of 3D hand poses and contact maps for numerous tasks performed by ordinary users across different object categories and different action categories.

Some embodiments are initially tailored to focus on predicting future 3D hand poses and contact maps from a single (or multiple) image showing the object, text describing the action, and a 3D contact point to localize the interaction. Such predictions are performed for diverse interactions in everyday activities.

Hands can be represented using a parametric mesh model. This model can include global translation information and rotation of wrist information. Given an object mesh, its 6 degrees of freedom (DoF) pose can be denoted using translation and rotation, signed distance field, or using basis point set distances. Because 3D hand-object motion annotations are typically unavailable for diverse objects (e.g., thin, occluded, or deformable objects), some embodiments instead focus on sequences of 3D hand poses and contact maps (i.e. interaction trajectories). Accordingly, the disclosed embodiments bring about numerous benefits, advantages, and practical applications to how interactions between non-modeled objects and grasping units (e.g., a human hand or perhaps a robotic hand) are implemented.

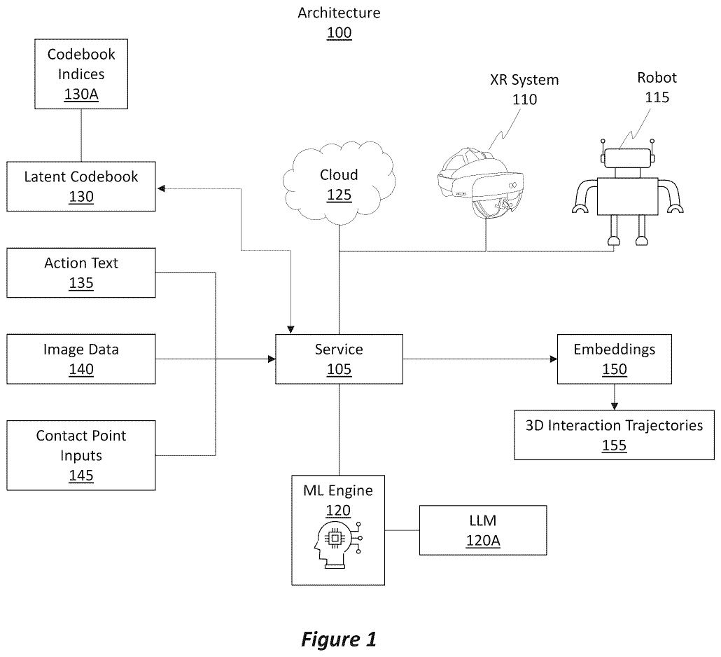

Having just described some of the high-level benefits, advantages, and practical applications achieved by the disclosed embodiments, attention will now be directed to FIG. 1, which illustrates an example computing architecture 100 that can be used to achieve those benefits. Architecture 100 includes a service 105, which can be implemented by an XR system 110 comprising an HMD. Additionally, or alternatively, service 105 can be implemented by a robot 115 or any type of autonomous entity.

As used herein, the phrases XR system, HMD, XR platform, XR device, or wearable device can all be used interchangeably and generally refer to a type of system that displays holographic content (i.e. holograms). In some cases, XR system 110 is of a type that allows a user to see various portions of the real world and that also displays virtualized content in the form of holograms. That ability means XR system 110 is able to provide so-called “passthrough images” to the user. In other scenarios, the XR system 110 is a virtual reality system such that direct viewing of the real world is not available. Architecture 100 can be implemented on any MR, AR, or VR system.

As used herein, the term “robot” generally refers to any type of programmable machine that is designed to perform one or more tasks in an automated manner. These tasks can be complex or they can be simple. Robots can take many forms and are not limited herein to any specific form. Robots can be mobile or they can be stationary.

As used herein, the term “service” refers to an automated program that is tasked with performing different actions based on input. In some cases, service 105 can be a deterministic service that operates fully given a set of inputs and without a randomization factor. In other cases, service 105 can be or can include a machine learning (ML) or artificial intelligence engine, such as ML engine 120. The ML engine 120 enables the service to operate even when faced with a randomization factor. Optionally, the ML engine 120 can include a large language model (LLM) 120A.

As used herein, reference to any type of machine learning, LLM, or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 105 is a cloud service operating in a cloud 125 environment. In some implementations, service 105 is a local service operating on a local device, such as the XR system 110 or the robot 115. In some implementations, service 105 is a hybrid service that includes a cloud component operating in the cloud 125 and a local component operating on a local device. These two components can communicate with one another.

Service 105 is generally tasked with learning or facilitating the learning of a latent codebook 130 of affordances, where the latent codebook 130 includes various codebook indices 130A. Service 105 is also tasked with mapping certain text or instruction text (e.g., action text 135, such as “pull the lever”), image data 140 (e.g., an image showing the lever), and a set of contact point inputs 145 to the codebook indices 130A to obtain embeddings 150. Service 105 then takes certain the embeddings 150, the action text 135, the image data 140, and the contact point inputs 145 and generates an output comprising one or more 3D interaction trajectories 155.

Service 105 can generate or facilitate the generation of a latent codebook of a vector describing an action performed against an object by translating video data to vector data, resulting in an inference of contact points between a gripping structure (e.g., perhaps a human hand or a robotic hand) and the object. Here, the contact points facilitate performance of the action. To do so, service 105 accesses a recording in which a gripping structure is performing an action against an object. The recording includes time-series data illustrating performance of the action by the gripping structure over a period of time. From the recording, service 105 generates interaction trajectories of the gripping structure performing the action.

The interaction trajectories are generated by creating a sequence of three dimensional (3D) poses (optionally skeleton illustrations) of the gripping structure while the gripping structure is performing the action. They are also generated by determining, for each 3D pose included in the sequence of 3D poses, a corresponding set of contact points between the gripping structure and the object during performance of the action.

Service 105 then generates embeddings from the interaction trajectories. Service 105 also includes the embeddings in a latent codebook.

After the latent codebook is generated, service 105 can generate instructions indicating how an action is performed against an object that was not previously mapped in the latent codebook. To do so, service 105 accesses the latent codebook, which includes a vector. The vector describes a specific action that is performed by a first gripping structure against a first object. The vector describes the specific action by mapping a trajectory of contact points (e.g., affordances) between the first gripping structure and the first object during performance of the specific action.

Service 105 then accesses an image of a second object that is to be manipulated. The second object is different from the first object. Optionally, the second image can be a robot hand or a human hand. Service 105 obtains an instruction indicating that the specific action is to be performed against the second object.

In response to accessing the vector in the latent codebook, service 105 uses the image to localize the vector to the second object. Localizing the vector to the second object includes modifying a first dimensionality associated with the first object, as described in the vector, to account for a second dimensionality of the second object, as identified by the image. As a result, a new trajectory of new contact points (e.g., affordances) between a second gripping structure and the second object are generated.

Service 105 then generates a sequence of instructions that represent the specific action as applied to the second object. The sequence of instructions identifies the new trajectory of the new contact points between the second gripping structure and the second object. Consequently, the sequence of instructions facilitates performance of the specific action against the second object.

For physically aware copilot experiences on varied devices, and for training robots to do day-to-day tasks, a notable problem is to learn 3D models of hand-object-interactions so that human-in-the-loop copilot experiences and robots can be instructed on dexterous and common procedural tasks via 3D visualization and parametric learned models. As described above, service 105 develops and demonstrates a novel generative AI model for modeling 3D affordances when hands manipulate tools and objects in simple to complex scenarios such as manipulating levers, pushing buttons, assembling parts, and similar real-world tasks. In contrast with current approaches in which researchers use data captured in lab settings to train generative models, service 105 employs a dataset such as HoloAssist that captures varied humans performing day-to-day and dexterous tasks.

The data (e.g., the recording mentioned earlier) can be captured via multimodal captures using a first-person view device, such as an HMD, or any type of third-person data. Service 105 pre-processes the data to generate pseudo-ground-truth data to train the generative models. Service 105 first trains a generative encoder-decoder model that generatively models the distribution of hand-object-interactions over diverse actions, objects, and hand-object-interactions. The inputs to the model consist of the data created via the pseudo-ground-truth step.

Service 105 also trains a generative model to synthesize a new hand-object-interaction trajectory in 3D given a textual description of the task and a single view of the object to be interacted with. The synthesis model automatically determines the samples to be used from the first generative model and conditions these with the specified action and the image to generate a relevant synthesized hand pose and articulation and trajectory to accomplish the specified task for the object provided.

Service 105 enables copilot guidance in XR settings where humans are either being trained to perform tasks or experienced operators need task level clarification on steps in a complex procedure. For instance, a trainee can ask the model to show how a lever needs to be operated in a machine, and the model will generate the appropriate hand articulations and trajectories with respect to the target object and its part to show the expected action.

Because the generative models explicitly model the 3D hand pose and articulations and also model the 3D contact points between an object part and the hand, it simplifies and improves the task of transferring the human hand articulation to a robot hand. Instead of training the robot hand directly from videos (which is a complex problem), service 105 reduces the transfer problem to a much lower dimensional mapping problem, such as: learn how to articulate a robot hand given the low dimensional representation of the human hand.

The explicitly computed contact points further enable the robot training by directing the robot hand to connect with the object part in a targeted way. Service 105 is extensible in its architecture to be trained and used with large datasets and with even more varied and complex actions. Service 105 can also use 3D models of objects if available and can also touch based inputs to instantiate the contact points. Any dataset that already has contact points and/or 3D hands in a ground truth form can be directly used in the model training.

The disclosed models have a positive impact on human-in-the-loop copilot instructional applications where humans can naturally query a copilot to demonstrate performance of specific tasks on machines and equipment. The disclosed models also have a positive impact on robotic applications, especially humanoid robots, which use intermediate 3D representations of human hands and object affordances to transfer lower dimensional learned models to a variety of robot hands. The disclosed operations reduce the cost of specific robot data collection and also potentially achieve higher accuracy since the human hand models and object affordances can be learned from a myriad of open sources as well as public and other datasets available for humans performing myriad tasks in homes, at work, and in factories.

Indeed, video datasets collected from assembly lines and factory floors can be utilized to create 3D hand-object-interaction generative models. These can be used for verification of tasks being done by humans. Use of human action video data opens up possibilities of using very large-scale datasets for object-interaction trained models whereas end-to-end datasets for robot operations are severely limited in their diversity and scale. Service 105 beneficially produces 3D hand pose and articulations for actions along with a contact map for the hand that highlights the object/part grasp points and contact points.

Current research on HOI (Hand-Object-Interaction) models largely employs controlled lab collected datasets with orchestrated and carefully created hand-object-interactions for simple tasks. Large scale datasets do exist for first person and third person multimodal captures of humans performing day-to-day and dexterous tasks. These datasets have been used for limited tasks such as action detection, action segmentation, anomaly detection. They have not been employed to create HOI representations in 3D.

One benefit disclosed herein relates to using datasets “in the wild” that depict commonly occurring scenarios of humans performing simple to complex procedural tasks with their hands and arms with real world settings of clutter in kitchens, living rooms, and other environments. A beneficial key insight is that representing HOIs in an “affordance-centric” form provides a natural representation of hand-object-interactions that can be made independent of the specific camera viewpoints and parameters with which the data was captured.

In contrast with previous approaches where hand annotated data sets are used, service 105 generates and auto-curates data for training by employing a novel pipeline. The data generation pipeline creates data suitable for training novel representations. From raw videos, service 105 can use models and algorithms to compute hands in 3D, contact points in images, and 3D and segmentation of object parts involved in hand-object-interactions. Service 105 curates the automatically generated dataset with quality metrics that eliminate unusable/unreliable data and filters the data into usable data for training of the disclosed encoding models and decoding models for generation of novel scenarios.

Service 105 can also use already curated, manually annotated datasets. However, since manually annotated datasets are invariably limited in scale, diversity, complexity of actions, and realism, it is often beneficial to build and demonstrate the disclosed approach on data “in the wild” without manual annotations. The disclosed approach is extensible with new actions and task types, new first person and third person videos of humans performing simple, and complex procedural actions. The disclosed principles also jointly estimate 3D hand pose and articulation parameters as well as the contact point affordances with respect to hand and object surfaces. This is also in contrast with previous approaches where researchers have assumed the availability of 3D models of objects, a requirement that is not practical or realistic to meet in the real world.

The disclosed affordance centric representation of hands and object parts in motion and articulation is also unique. The 3D modeling of the affordance-centric representation directly enables both human-in-the-loop physically aware copilot scenarios as well as transfer learning tasks for robot hands. It can be observed how 3D hand pose and articulation jointly with 3D contact point estimation is adequate to give a human trainee or user an indication of how a given action needs to be performed with respect to a given object or object part.

At least some of the disclosed embodiments also develop and demonstrate a decoder that uses a sample from the hand pose-articulation distribution conditioned by an input task specification as text and an image of the target object/part, to generate a novel hand articulation and motion that mimics the execution of the task specified on the target object.

The overall approach towards affordance-centric representation has (though is not limited to) the following technical advantages. One advantage is that the embodiments do not need an explicit object model to be available. Another advantage is that the embodiments can represent the hand-object-interaction in a natural object-affordance centric coordinate system that can be transformed into any camera view for depiction and visualization. Yet another advantage is that the embodiments do not require hand annotated training datasets but can use these if available.

Yet another advantage is that the embodiments extract training data by processing first-person/third-person raw videos of humans performing simple and complex tasks. Yet another advantage is that the embodiments do not require clean clutter-free lab settings since the embodiments can derive the relevant object part, affordances, and hands from the videos themselves. Yet another advantage is that the embodiments create explicit 3D representation of hand poses, articulation trajectories, and contact points that dynamically change over the execution of a task.

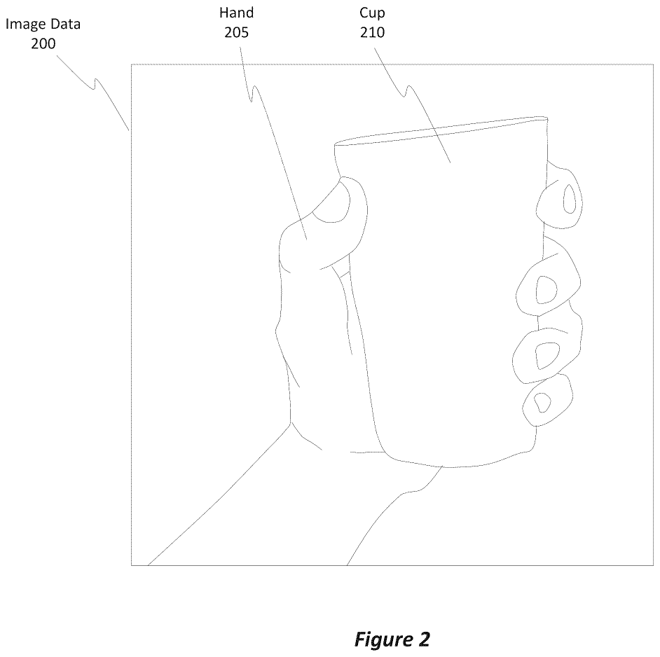

For example, consider the scenarios presented in FIGS. 2, 3, and 4. FIG. 2 shows example image data 200, which corresponds to the image data 140 of FIG. 1. In FIG. 2, a person's hand 205 is grasping a cup 210. In this scenario, the cup 210 is a type of object that does not have a unique 3D model associated with it, as mentioned previously.

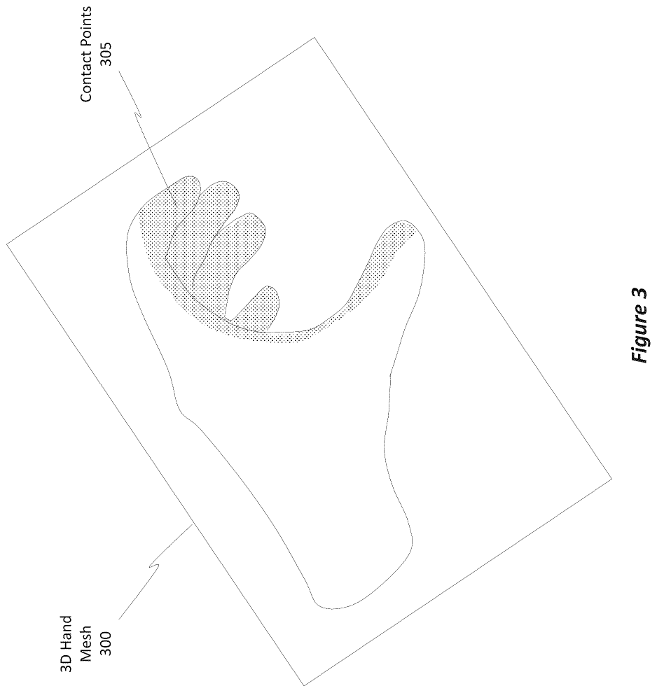

FIG. 3 shows a 3D hand mesh 300 derived from the image data 200 of FIG. 2. Note, the 3D hand mesh 300 includes data indicating the contact points 305 (e.g., affordances) between the user's hand 205 and the cup 210. That is, the dotted pattern in FIG. 3 corresponds to the points of contact that exist between the user's hand 205 and the cup 210.

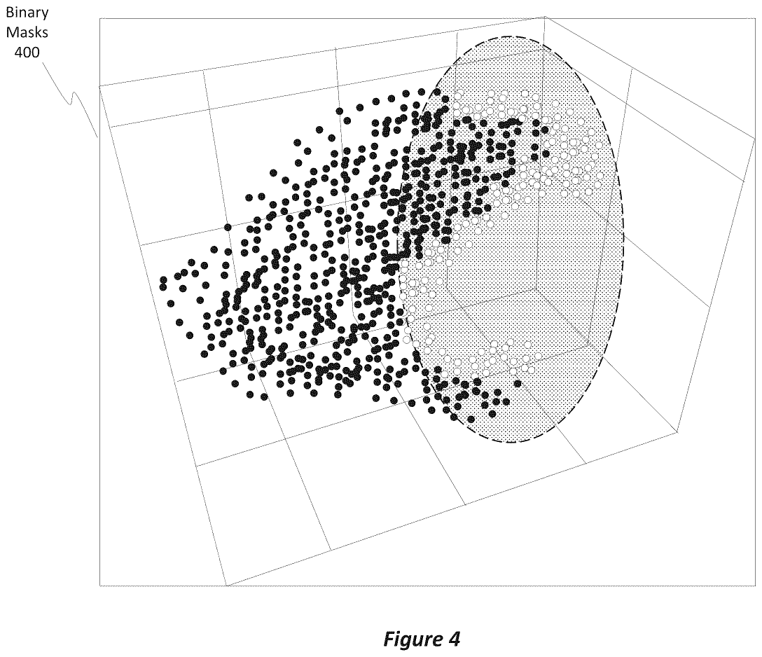

Some embodiments represent the contact points 305 as binary masks 400 (shown in FIG. 4) on the hand mesh vertices. For instance, in FIG. 4, the hand mesh is represented in the camera coordinate system, consisting of the local hand pose in the MANO (“hand Model with Articulated and Non-rigid defOrmations”) coordinate frame and a global transformation from the MANO frame to the camera frame. The aggregation of these hand poses and their corresponding contact points (over several timesteps) form the 3D interaction trajectories 155.

Regarding the 3D hand mesh 300 of FIG. 3, some embodiments (as mentioned above) use the MANO model to represent the hand. The MANO model consists of pose θ and shape β parameters, which can be converted to a 3D hand mesh. These mesh vertices lie in the MANO coordinate system, which can be transformed to the camera coordinate system at the first timestep (reference frame) using a rotation and translation. Doing so provides service 105 with the hand trajectory in the reference frame.

Regarding the contact map, some embodiments represent the contact points as a binary mask over the MANO hand mesh vertices, i.e., a 778 dimensional binary vector for each timestep, referred to as a “contact map.” The contact points may also change over time depending on the action, e.g. twisting.

Once the 3D hand mesh is transformed into reference frame, service 105 can estimate the trajectory of the contact points by computing the centroid of the contact points at each timestep. The contact centroid in the reference frame is used as the 3D contact point input during training. Service 105 can assume a 3D contact point to be available in the first frame at test time. To input this point, service 105 creates (in one example implementation) a 3D voxel grid of resolution 16×16×16. Service 105 takes minimum and maximum values of a 3D hand trajectory (along each axis, in the reference frame) across all training sequences. This span is divided into 16 equal parts per axis, associating each voxel to 3D metric range. It is kept fixed at train and test time. Thus, the center of each voxel represents a 3D location in metric space, i.e. a 3D metric grid, in the camera coordinate system. Service 105 can also create a 3D gaussian heatmap centered at 3D contact point in this grid, referred to as voxelized contact points. This changes as the trajectory evolves. This is different than the contact map (binary mask over mesh vertices).

Some embodiments implement a so-called “interaction codebook (aka InterCode). The interaction codebook can be implemented as a VQVAE with a transformer encoder-decoder architecture. In some scenarios, the interaction codebook includes three modules. One module is an encoder. Here, the hand and contact map trajectories for a fixed time horizon T are passed to a transformer encoder to obtain the feature embedding. These features are used to query the latent codebook 130 to obtain the relevant embeddings using L2 distance. Specifically, the input trajectory, consisting of MANO parameters and contact maps, is first passed to a 1-layer MLP (multilayer perceptron model) to match the feature dimension of the transformer. Some embodiments use a 1-layer transformer encoder with 1 head and feature dimension=512. It outputs a T×512-dimensional feature.

Another module is the latent codebook 130 from FIG. 1. The latent codebook 130 is initialized as a K×E dimensional matrix and is updated during training using exponential moving average of the embeddings output from the encoder. Some embodiments use a multilayer residual VQVAE architecture. Some embodiments set the number of quantizers for VQVAE to 6, K=512 and E=512. When querying the latent codebook 130 during training, sampling can be done using the Gumbel-SoftMax trick to preserve differentiability. Some embodiments set the temperature of Gumbel-Softmax to 0.5 and inject noise at training for stochastic sampling. At test time, argmax is used to obtain the closest codebook entry.

The third module is a decoder. The decoder takes multiple inputs, namely: (1) the latent embeddings queried from the latent codebook 130 (T×512), (2) CLIP embeddings of the text describing the action (512 dimensional feature extended for T timesteps), (3) DeiT embeddings of the video showing the actions (T×768), and (4) voxelized contact points at each timestep, which are passed through four 3D convolution layers. Some embodiments also pass in a 4D grid with each voxel containing the 3D location of its center in metric space and process it with 3D convolution layers. This returns a 32-dimensional feature vector from the contact module. Concatenating all these input features, some embodiments obtain a 1824-dimensional joint feature that is passed through a 1-layer MLP to change the dimensionality to 512 and then fed to a transformer decoder (1-layer with 1 head and dropout of 0.2). The query embeddings for the transformer decoder are set as trainable parameters. The decoder outputs a T×512 feature map which is passed to separate decoders for predicting the MANO parameters and the contact map. Some embodiments use a 2-layer MLP to predict the MANO parameters and a 3-layer MLP to predict the contact maps for the entire time horizon T.

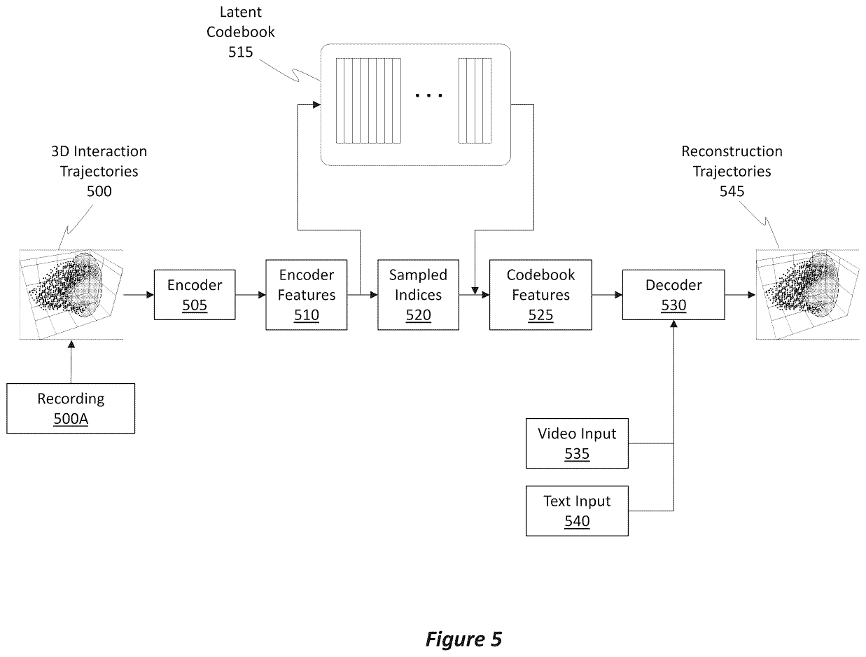

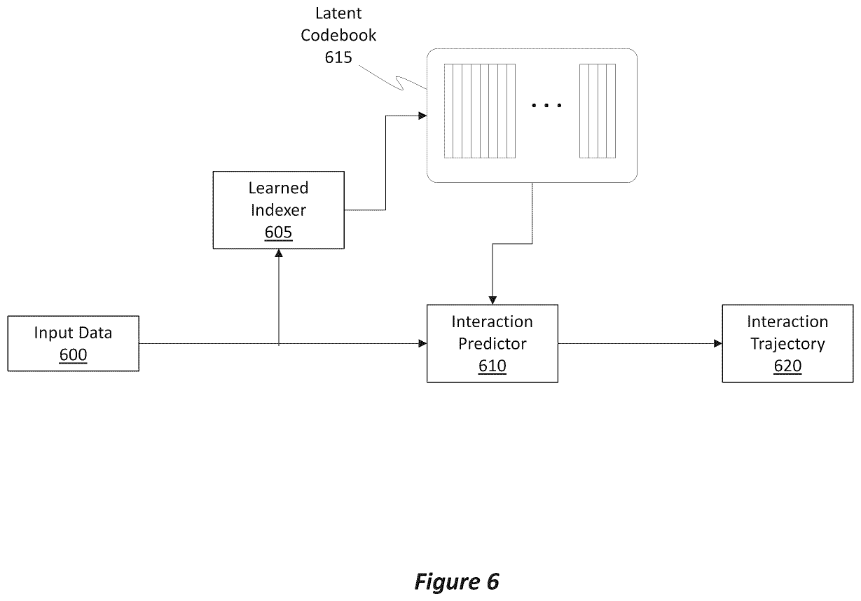

Regarding training, the loss function consists of several terms, namely: (1) smooth L1 loss on the MANO parameters, (2) L1 loss on the contact centroid, (3) L1 loss on the translation between the future frame and first frame, (4) L1 loss on the 6D rotation representation between the future frame and first frame, and (5) binary cross-entropy loss on the contact map predictions. FIGS. 5 and 6 provide additional details.

As generally shown in FIGS. 5 and 6, one aspect of the disclosed framework involves a 2-stage training procedure. FIG. 5 focuses on the interaction codebook and the process of learning a latent codebook of hand poses and contact points, i.e., tokenizing interaction trajectories. FIG. 6 focuses on a learned indexer and an interaction predictor module that predicts the interaction trajectories from a single image, action text, and a set of 3D contact points. Some embodiments use pretrained features for images (e.g., from DeiT) and text (e.g., from CLIP). The one or more 3D contact points are input as a 3D gaussian heatmap in a 3D voxel grid.

Regarding FIG. 5, the interaction codebook is a VQVAE model that learns a latent codebook of 3D interaction trajectories consisting of a transformer encoder-decoder architecture. The encoder features are used to sample codebook indices and corresponding embeddings which are passed to a decoder that also takes in the video input and text describing the action and reconstructs the 3D interaction trajectories. To illustrate, FIG. 5 shows an initial set of 3D interaction trajectories 500, which may be generated from a recording 500A. This initial set of 3D interaction trajectories 500 are processed by an encoder 505, which generates encoder features 510. The encoder features 510 are used to sample the latent codebook 515, as shown by the sampled indices 520. Codebook features 525 are also obtained and then passed to the decoder 530, which also receives as input the video input 535 and the text input 540. The decoder 530 then reconstructs the reconstruction trajectories 545.

With reference to FIG. 6, some embodiments train an indexer module to map the inputs at test time to the codebook indices to extract the relevant embeddings. These are then passed to an interaction predictor module that outputs the 3D interaction trajectories. Some embodiments consider two settings, namely: (1) forecasting, which involves text describing the action, a single image, and a 3D contact point, and (2) interpolation, which involves providing the goal image showing the final state of the interaction. For instance, in FIG. 6, input data 600 is provided to the learned indexer 605 and the interaction predictor 610. The input data 600 is mapped to the latent codebook 615 to extract the relevant embeddings. The result of these actions is then the generation of the interaction trajectory 620. Further details are provided below.

Regarding the learned indexer 605, at test time, it is desirable to query the latent codebook 615 to obtain the latent interaction embeddings. This is done using a learned module that takes the test time inputs, i.e. text describing an action, image showing an object, and a 3D contact point and outputs a probability distribution over the codebook indices. The indices and corresponding embeddings can be sampled using the predicted probabilities. Note, the test time inputs include a single image and a 3D contact point, unlike the entire trajectory used for training InterCode. Some embodiments first compute features from different inputs, such as: CLIP embedding of text, DeiT embeddings of images, features from voxelized contact points, and the reference frame. Such computations may be performed after passing through four 3D convolutional layers. Some embodiments concatenate these features and process them through a 2-layer MLP to match the input dimensions of the transformer classifier module. It is implemented as a 1-layer, 1-head transformer decoder layer that takes in learnable query embeddings and aforementioned features from different modalities to output T×512 dimensional features. These features are then passed to a 3-layer MLP to output a probability distribution over the indices of the codebook. The training consists of a cross-entropy loss with ground truth computed as the closest codebook indices (L2 distance) from the encoder features of the InterCode module.

Regarding the interaction predictor 610 (InterPred), because the inputs at test time differ from the decoder inputs of the InterCode module during training, it is beneficial to separate learned modules to predict the interaction trajectories. Such a process consists of a transformer decoder module with the following inputs: (1) the latent embeddings queried from the codebook using the learned prior, (2) CLIP embeddings of the text describing the action, (3) DeiT embeddings of the image showing the object, and (4) voxelized contact point in the reference frame. These inputs are processed in the same way as for the learned indexer 605 before passing to the transformer decoder. The architecture is same as the decoder in Inter-Code. While the inputs are different than InterCode, they are passed to an MLP to match transformer dimension. For training, the loss function consists of several terms: (1) smooth L1 loss on the MANO parameters, (2) L1 loss on the contact centroid, (3) L1 loss on the translation between the future frame and first frame, (4) L1 loss on the 6D rotation representation between the future frame and first frame, and (5) binary cross-entropy loss on the contact map predictions.

Existing lab datasets are typically limited to simple interactions in constrained setups. In contrast, some of the disclosed embodiments use egocentric videos showing everyday interactions with rigid, articulated, and deformable objects (e.g., operating machines, tool use, kitchen tasks, etc.). A corpus of videos can include 2,000+ videos with temporally localized atomic actions, such as grab, open, screw, mix, rotate, align, slide, and so on with diverse objects.

Some embodiments extract these clips of atomic actions and convert them into the required format for training and evaluation. In one example scenario, some embodiments consider 24 action categories with 120 object categories spanning 800 tasks. It is also desirable to provide 3D annotations for hand poses and contact points. To extract these annotations, some embodiments include a designed semi-automatic data pipeline using 2D segmentation masks, 3D hand poses, and 2D contact region.

Regarding the 2D segmentation masks, some embodiments adopt a semi-automatic approach for object masks, where this approach involves clicking a point on the target object in the first frame of a video and tracking the object mask across the video. For 2D hand masks, some embodiments render the 3D hand mesh into the image.

Regarding the 3D hand poses, some embodiments use different models to obtain 3D hand meshes in each video frame. As one example, a HaMeR model takes an image crop around the hand as input. The predicted 3D mesh in each frame is transformed to the reference frame using known intrinsics and extrinsics available.

Regarding the 3D contact points, some embodiments first compute a 2D contact region in an image as the overlap between the hand and object masks. Such embodiments add gaussian noise at the boundary to obtain a dense 2D contact region. These embodiments back project the 2D contact region into 3D hand mesh to obtain 3D contact points on the hand mesh.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

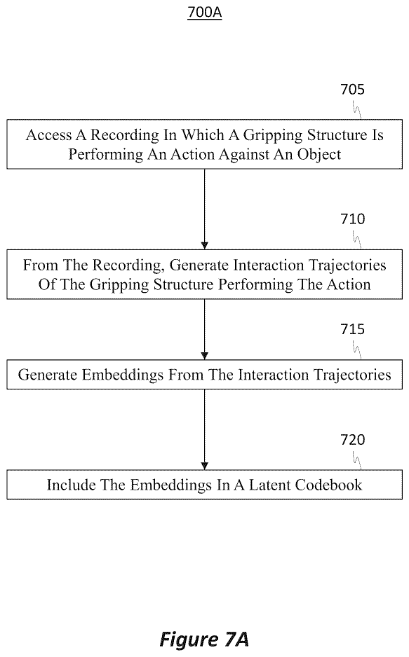

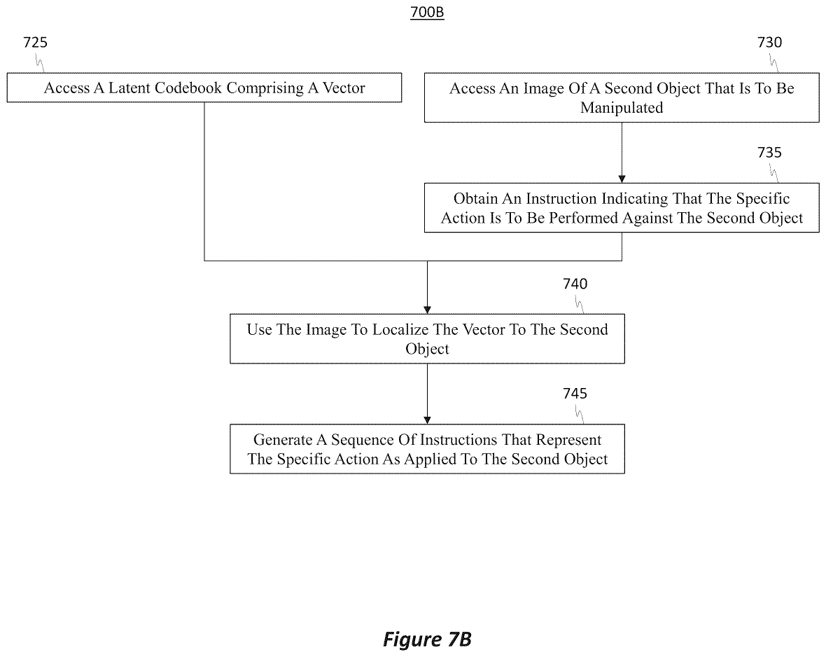

Attention will now be directed to FIGS. 7A and 7B, which illustrate various different flowcharts of example methods that can be performed within the architecture 100 of FIG. 1 and more specifically can be performed by service 105. In particular, FIG. 7A shows a flowchart of an example method 700A for generating a latent codebook of a vector describing an action performed against an object by translating video data to vector data, resulting in an inference of contact points between a gripping structure and the object. Notably, the contact points (e.g., affordances) facilitate performance of the action.

Method 700A includes an act (act 705) of accessing a recording in which a gripping structure is performing an action against an object. The recording includes time-series data illustrating performance of the action by the gripping structure over a period of time. In one example scenario, the gripping structure is a human hand.

In one example scenario, the action is one of a rotation action, a pull action, a push action, or a lateral move action. Other actions can be performed as well. In another scenario, the action includes a coordinated movement of the object from a first location to a second location.

Optionally, the recording is generated by one of: a red-green-blue (RGB) camera, a depth camera, an ultraviolet (UV) light camera, or an infrared (IR) light camera. Other camera types can be used as well.

From the recording, there is an act (act 710) of generating interaction trajectories of the gripping structure performing the action by performing a number of sub-operations. One such sub-operation includes generating a sequence of three dimensional (3D) poses of the gripping structure while the gripping structure is performing the action. Another such sub-operation includes determining, for each 3D pose included in the sequence of 3D poses, a corresponding set of contact points between the gripping structure and the object during performance of the action. In some scenarios, at least some of the set of contact points are inferred contact points as a result of a part of the gripping structure being occluded for at least a period of time during the recording. The set of contact points can be represented as binary masks on a mesh data structure. Optionally, the interaction trajectories include gripping structure poses and contact points over a plurality of timesteps.

Act 715 then includes generating embeddings from the interaction trajectories. Optionally, the embeddings include information describing synthesized poses of the gripping structure in combination of articulations and trajectories of the gripping structure. Optionally, the embeddings include information describing synthesized poses of the gripping structure in combination of articulations and trajectories of the gripping structure.

Act 720 involves including the embeddings in a latent codebook. Optionally, the latent codebook comprises a plurality of vectors, each describing a corresponding different action.

FIG. 7B shows a flowchart of an example method 700B that can be performed after the latent codebook is generated in accordance with method 700A of FIG. 7A. Specifically, method 700B involves the generation of instructions indicating how an action is performed against an object that was not previously mapped in the latent codebook.

Act 725 of method 700B includes accessing a latent codebook comprising a vector. The vector describes a specific action that is performed by a first gripping structure against a first object. The vector describes the specific action by mapping a trajectory of contact points between the first gripping structure and the first object during performance of the specific action. Optionally, the latent codebook comprises a plurality of vectors, each describing a corresponding action.

Act 730 includes accessing an image of a second object that is to be manipulated. Notably, the second object is different from the first object. In some scenarios, the image is augmented to include an indication of the second object or, alternatively, the second object is identified via object segmentation. In some scenarios, the image is generated by one of: a red-green-blue (RGB) camera, a depth camera, an ultraviolet (UV) light camera, or an infrared (IR) light camera. Notably, the second object is not modeled in the latent codebook.

Act 735 includes obtaining an instruction indicating that the specific action is to be performed against the second object. Optionally, the specific action is one of a rotation action, a pull action, a push action, or a lateral move action. Other actions can be performed as well. For instance, the specific action can include a coordinated movement of the second object from a first location to a second location.

In some scenarios, the instruction indicates that the specific action is to be performed against the second object is a text-based instruction. Additionally, or alternatively, the instruction indicating that the specific action is to be performed against the second object is an audio instruction. The specific action can additionally or alternatively include articulation of the second object.

In response to accessing the vector in the latent codebook, act 740 includes using the image to localize the vector to the second object. The process of localizing the vector to the second object includes modifying a first dimensionality associated with the first object, as described in the vector, to account for a second dimensionality of the second object, as identified by the image. Consequently, a new trajectory of new contact points between a second gripping structure and the second object are generated. Optionally, the first gripping structure is a human hand, and the second gripping structure is a robotic hand.

Act 745 includes generating a sequence of instructions that represent the specific action as applied to the second object. Here, the sequence of instructions identifies the new trajectory of the new contact points between the second gripping structure and the second object, such that the sequence of instructions facilitates performance of the specific action against the second object. In some scenarios, the generated sequence of instructions are provided to a robot, instructing the robot to perform the specific action on the second object in accordance with the generated sequence of instructions using a robotic hand. In some scenarios, the generated sequence of instructions are implemented by a hologram displayed within an extended reality scene. In some scenarios, the sequence of instructions includes information describing synthesized poses of the second gripping structure in combination of articulations and trajectories of the second gripping structure. Optionally, the sequence of instructions includes three-dimensional mesh data structures. As another option, the sequence of instructions includes binary mask data structures.

In some implementations, the process of modifying the first dimensionality associated with the first object to account for the second dimensionality of the second object includes a number of steps. One step includes identifying a first contact point of a first appendage of the first gripping structure. Another step includes shifting the first contact point to a new position. Another step includes attributing the new pose/position to a second contact point of a second appendage of the second gripping structure to account for a difference in size between the first object and the second object.

In some implementations, the process of modifying the first dimensionality associated with the first object to account for the second dimensionality of the second object includes a number of steps. One step includes identifying a pose of a first appendage of the first gripping structure. Another step includes shifting the pose to a new pose. Another step includes attributing the new pose/position to a second appendage of the second gripping structure to account for a difference between the first object and the second object.

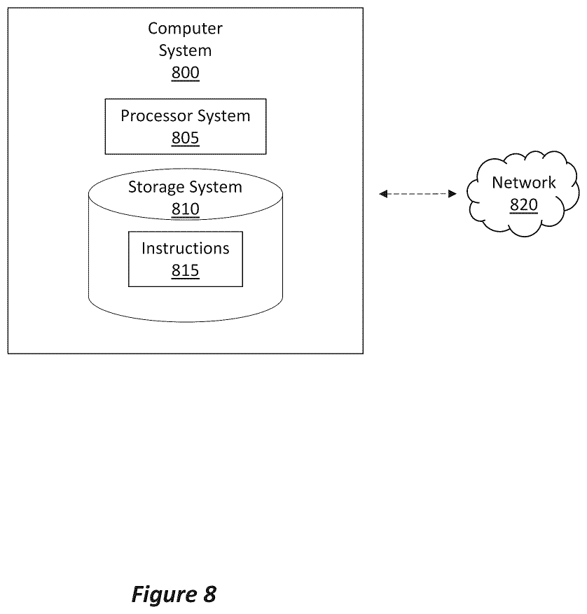

Attention will now be directed to FIG. 8 which illustrates an example computer system 800 that may include and/or be used to perform any of the operations described herein. For instance, computer system can implement service 105 of FIG. 1. Computer system can also take the form of XR system 110 or the robot 115.

Computer system 800 may take various different forms. For example, computer system 800 may be embodied as a tablet, a desktop, a laptop, a mobile device, or a standalone device, such as those described throughout this disclosure. Computer system 800 may also be a distributed system that includes one or more connected computing components/devices that are in communication with computer system 800.

In its most basic configuration, computer system 800 includes various different components. FIG. 8 shows that computer system 800 includes a processor system 805, which may include one or more processor(s) (aka a “hardware processing unit”) and a storage system 810.

Regarding the processor(s) of processor system 805, it will be appreciated that the functionality described herein can be performed, at least in part, by one or more hardware logic components (e.g., the processor(s)). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computer system 800. The different components, modules, engines, and services described herein may be implemented as objects or processors that execute on computer system 800 (e.g. as separate threads).

Storage system 810 may be physical system memory, which may be volatile, non-volatile, or some combination of the two. The term “memory” may also be used herein to refer to non-volatile mass storage such as physical storage media. If computer system 800 is distributed, the processing, memory, and/or storage capability may be distributed as well.

Storage system 810 is shown as including executable instructions 815. The executable instructions 815 represent instructions that are executable by the processor(s) of processor system 805 to perform the disclosed operations, such as those described in the various methods.

The disclosed embodiments may comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 800 may also be connected (via a wired or wireless connection) to external sensors (e.g., one or more remote cameras) or devices via a network 820. For example, computer system 800 can communicate with any number devices or cloud services to obtain or process data. In some cases, network 820 may itself be a cloud network. Furthermore, computer system 800 may also be connected through one or more wired or wireless networks to remote/separate computer systems(s) that are configured to perform any of the processing described with regard to computer system 800.

A “network,” like network 820, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 800 will include one or more communication channels that are used to communicate with the network 820. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for generating instructions indicating how an action is performed against an object that was not previously mapped, said method comprising:
accessing a latent codebook comprising a vector, wherein the vector describes a specific action that is performed by a first gripping structure against a first object, wherein the vector describes the specific action by mapping a trajectory of contact points between the first gripping structure and the first object during performance of the specific action;
accessing an image of a second object that is to be manipulated, wherein the second object is different from the first object;
obtaining an instruction indicating that the specific action is to be performed against the second object;
in response to accessing the vector in the latent codebook, using the image to localize the vector to the second object, wherein localizing the vector to the second object includes modifying a first dimensionality associated with the first object, as described in the vector, to account for a second dimensionality of the second object, as identified by the image, such that a new trajectory of new contact points between a second gripping structure and the second object are generated; and
generating a sequence of instructions that represent the specific action as applied to the second object, wherein the sequence of instructions identifies the new trajectory of the new contact points between the second gripping structure and the second object, such that the sequence of instructions facilitates performance of the specific action against the second object.

2. The method of claim 1, wherein the first gripping structure is a human hand, and wherein the second gripping structure is a robotic hand.

3. The method of claim 1, wherein the specific action is one of a rotation action, a pull action, a push action, or a lateral move action.

4. The method of claim 1, wherein the image is augmented to include an indication of the second object or, alternatively, the second object is identified via object segmentation.

5. The method of claim 1, wherein the image is generated by one of: a red-green-blue (RGB) camera, a depth camera, an ultraviolet (UV) light camera, or an infrared (IR) light camera.

6. The method of claim 1, wherein the instruction indicating that the specific action is to be performed against the second object is a text-based instruction.

7. The method of claim 1, wherein the instruction indicating that the specific action is to be performed against the second object is an audio instruction.

8. The method of claim 1, wherein the second object is not modeled in the latent codebook.

9. The method of claim 1, wherein the generated sequence of instructions are provided to a robot, instructing the robot to perform the specific action on the second object in accordance with the generated sequence of instructions using a robotic hand.

10. The method of claim 1, wherein the generated sequence of instructions are implemented by a hologram displayed within an extended reality scene.

11. A computer system comprising:
a processor system; and
a storage system that stores instructions that are executable by the processor system to cause the computer system to:
access a latent codebook comprising a vector, wherein the vector describes a specific action that is performed by a first gripping structure against a first object, wherein the vector describes the specific action by mapping a trajectory of contact points between the first gripping structure and the first object during performance of the specific action;
access an image of a second object that is to be manipulated, wherein the second object is different from the first object;
obtain an instruction indicating that the specific action is to be performed against the second object;
in response to accessing the vector in the latent codebook, use the image to localize the vector to the second object, wherein localizing the vector to the second object includes modifying a first dimensionality associated with the first object, as described in the vector, to account for a second dimensionality of the second object, as identified by the image, such that a new trajectory of new contact points between a second gripping structure and the second object are generated; and
generate a sequence of instructions that represent the specific action as applied to the second object, wherein the sequence of instructions identifies the new trajectory of the new contact points between the second gripping structure and the second object, such that the sequence of instructions facilitates performance of the specific action against the second object.

12. The computer system of claim 11, wherein the latent codebook comprises a plurality of vectors, each describing a corresponding action.

13. The computer system of claim 11, wherein the specific action includes a coordinated movement of the second object from a first location to a second location.

14. The computer system of claim 11, wherein the specific action includes articulation of the second object.

15. The computer system of claim 11, wherein the sequence of instructions includes information describing synthesized poses of the second gripping structure in combination of articulations and trajectories of the second gripping structure.

16. The computer system of claim 11, wherein the sequence of instructions includes three dimensional mesh data structures.

17. The computer system of claim 11, wherein the sequence of instructions includes binary mask data structures.

18. The computer system of claim 11, wherein modifying the first dimensionality associated with the first object to account for the second dimensionality of the second object includes:
identifying a first contact point of a first appendage of the first gripping structure;
shifting the first contact point to a new position; and
attributing the new position to a second contact point of a second appendage of the second gripping structure to account for a difference in size between the first object and the second object.

19. The computer system of claim 11, wherein modifying the first dimensionality associated with the first object to account for the second dimensionality of the second object includes:
identifying a pose of a first appendage of the first gripping structure;
shifting the pose to a new pose; and
attributing the new pose to a second appendage of the second gripping structure to account for a difference between the first object and the second object.

20. One or more hardware storage devices that store instructions that are executable by a processor system to cause the processor system to:
access a latent codebook comprising a vector, wherein the vector describes a specific action that is performed by a first gripping structure against a first object, wherein the vector describes the specific action by mapping a trajectory of contact points between the first gripping structure and the first object during performance of the specific action;
access an image of a second object that is to be manipulated, wherein the second object is different from the first object;
obtain an instruction indicating that the specific action is to be performed against the second object;
in response to accessing the vector in the latent codebook, use the image to localize the vector to the second object, wherein localizing the vector to the second object includes modifying a first dimensionality associated with the first object, as described in the vector, to account for a second dimensionality of the second object, as identified by the image, such that a new trajectory of new contact points between a second gripping structure and the second object are generated; and
generate a sequence of instructions that represent the specific action as applied to the second object, wherein the sequence of instructions identifies the new trajectory of the new contact points between the second gripping structure and the second object, such that the sequence of instructions facilitates performance of the specific action against the second object.
